(19) United States
(12) Patent Application Publication
(10) Pub. No.: US 2008/0249277 A1
(43) Pub. Date: Oct. 9, 2008

(54) Polyurethane elastomer for cleaning blade of electronic copying machine

(76) Inventors: Takeshi Sanjo, Nishinomiya City (JP); Takehiro Shimizu, Nishinomiya (JP); Kohichi Katamura, Kobe City (JP)

Correspondence Address: BAYER MATERIAL SCIENCE LLC, 100 BAYER ROAD, PITTSBURGH, PA, 15205, US

(21) Appl. No.: 12/072,178

(22) Filed: Feb. 25, 2008

(30) Foreign Application Priority Data
Feb. 27, 2007 (JP) 47211-2007

(51) Int. Cl. C08G 71/04

(52) U.S. Cl. 528/28

(57) ABSTRACT

A polyurethane elastomer useful as a cleaning blade of an electronic copying machine having a small temperature dependency over a wide range of atmospheric temperatures is produced by reacting (1) a polyol component, (2) a chain extender, and (3) an isocyanate component. The polyol component includes a bifunctional silicone oil having hydroxyl groups at both ends and containing an ester group. The isocyanate component includes an aromatic isocyanate. The silicone oil content of the elastomer is from 5.0 to 50% by weight, based on the weight of the polyurethane elastomer. In a preferred embodiment, the polyurethane elastomer is produced from a polyol component which includes a polycaprolactone ester polyol and a silicone oil having hydroxyl groups at both ends which also contains an ester group.

### BACKGROUND OF THE INVENTION

The present invention relates to a polyurethane elastomer which is particularly suitable for use on a cleaning blade of an electronic copying machine. This polyurethane elastomer has a small change in viscoelasticity (rubber elasticity) under a wide temperature range of atmosphere and an excellent low-temperature characteristic with glass transition temperature of −5 degrees C. or lower.

Conventionally, a cleaning blade is used for removing the toner which remains on the surface of photosensitive drums, such as the drums used in an electronic copying machine. Polyurethane elastomers are known as a material which is suitable for such applications.

A direct contact of the cleaning blade to the surface of a photosensitive drum, and, in recent years, the toner, which is made into fine particles in order to increase the freshness of printed states, will become difficult to be removed if it remains on the photosensitive drum surface, such as in printing. A polyurethane elastomer having high mechanical properties such as strength and elongation, that is elastic, and has low abrasive characteristics and excellent wear resistance is required.

The locations which use (or install) electronic copying machines, such as a copy machine and fax, are not usually limited to the inside of buildings in which the environment is constantly adjusted to a normal temperature. Frequently, they are in locations which, in many cases, are at an elevated temperature (an elevated-temperature region) or a cold temperature (a low-temperature region). Therefore, cleaning blades having little temperature dependency are required.

For example, at a location where the temperature is elevated, the hardness of the polyurethane elastomer may fall and the elasticity may go up too much. The removal of the toner which remains on the photosensitive drum surface is inadequate.

In a cold temperature environment, the viscoelasticity of a polyurethane elastomer is lost, the toner which remains on the surface of a photosensitive drum is inadequately removed, and troubles such as a blots and blurry print are caused.

JP-A-57-201275 describes a method for achieving a low friction coefficient of a polyurethane rubber by incorporating a fluorine-containing compound into the polyurethane rubber.

JP-A-57-201276 describes a method for achieving a low friction coefficient of a polyurethane rubber by incorporating a polysiloxane oil in the polyurethane rubber.

JP-A-5-224573 describes a method for obtaining a cleaning blade for electronic copying machine having a low coefficient of friction and excellent heat resistance by using a silicone-containing multi-components copolymer, and a saturated or unsaturated fatty acid amide. Since the amount of the polysiloxane diol used is small in this method, a polysiloxane chain hardly comes to the surface so that the effectiveness on low friction properties or physical properties is insufficient.

JP-A-7-290601 describes a method for producing a cleaning blade having a low-friction layer by using a polysiloxane monool having a hydroxyl group at one end for a urethane rubber. The use of a polysiloxane monool results in a urethane composition having a lower molecular weight and decreased strength.

JP-A-2003-186366 describes a method for obtaining an electronic copying-machine cleaning blade with excellent low-friction characteristics by using an organopolysiloxane having two primary hydroxyl groups at one end and no reactive group at the other end. A polysiloxane diol having two active hydrogen atoms at one end is insufficient, since disadvantageously a dimethylsilicone chain works as a side chain of a long chain and disturbs a molecular structure so that physical properties are deteriorated.

However, none of the above-mentioned disclosures describes a method for obtaining a polyurethane elastomer for the cleaning blade of an electronic copying machine which the has a small change of viscoelasticity under a wide range of temperature conditions, which has excellent low-temperature characteristics and which has a glass transition temperature of at most −5 degrees C.

Therefore, the development of the polyurethane elastomer for cleaning blade of electronic copying machine achieving sufficiently the functions of cleaning blade is desired, which polyurethane elastomer has the small change of the viscoelasticity under a wide range of circumferential temperature, and excellent low-temperature characteristics including the glass transition temperature of not larger than −5 degrees C.

### SUMMARY OF THE INVENTION

One of objects of the present invention is to provide a polyurethane elastomer for a cleaning blade of an electronic copying machine which has a small temperature dependency even under a wide range of temperature conditions, a small change of viscoelasticity (rubber elasticity), a glass transition temperature of not larger than −5 degrees C., and excellent low-temperature characteristics.

This and other objects which will be apparent to those skilled in the art are achieved by the polyurethane elastomer(s) described more fully below which are produced from a polyol component that includes a bifunctional silicone oil.

### DETAILED DESCRIPTION OF THE INVENTION

The present invention is directed to a polyurethane elastomer useful for a cleaning blade of an electronic copying machine. This polyurethane elastomer is the reaction product of (1) a polyol component, (2) a chain extender, and (3) an isocyanate component. The polyol component includes a silicone oil which is bifunctional, has hydroxyl groups at both ends and contains an ester group. The isocyanate component includes an aromatic isocyanate. The silicone oil content is from about 5.0 to about 50% by weight, based on the weight of the polyurethane elastomer.

The polyurethane elastomers of the present invention have a hardness of from 70 to 90 in shore A, a tan delta (10) value at 10 degrees C. of 0.32 or less, and a tan delta (55) value at 55 degrees C. of 0.02 or more in viscoelasticity with the difference between tan delta (10) and tan delta (55) being no greater than 0.30.

The polyurethane elastomers of the present invention satisfy the mechanical characteristics, such as hardness, strength and elongation, necessary for a cleaning blade of electronic copying machine. These elastomers also have a small temperature dependence under a wide atmospheric temperature range, for example, the range from 10 to 55 degrees C., and viscoelasticity (rubber elasticity) at a low-temperature range below 10 degrees C. due to the glass transition temperature of −5 degrees C. or lower.

Consequently, the polyurethane elastomers of the present invention when applied to a cleaning blade of an electronic copying machine, do not deteriorate during use even under a wide range of atmospheric temperatures.

The polyurethane elastomer from which a cleaning blade for an electronic copying machine is produced in accordance with the present invention is a reaction product of a polyol component (1), a chain extender (2), and an isocyanate component (3). The polyol component (1) contains a silicone oil having an ester group in the molecule and also having hydroxyl groups at both ends The isocyanate component (2) contains an aromatic isocyanate.

The polyurethane elastomer of the present invention has a Shore A hardness of 70 to 90, viscoelasticity tan δ (10) at 10 degrees C. of at most 0.32, and viscoelasticity tan δ (55) at 55 degrees C. of at least 0.02. The difference between δ (10) and δ (55) is at most 0.30.

The use of a polyurethane elastomer having these properties for the cleaning blade of the electronic copying machine results in a cleaning blade which does not spoil the performance copying machine even under a wide range of atmospheric temperature conditions.

The polyurethane elastomer used for a cleaning blade of an electronic copying machine in accordance with the present invention is preferably made with a polyol component that includes a silicone oil which contains an ester group in a molecule and which is difunctional (diol) having hydroxyl groups at both ends. The polyol component may be made up solely of the silicone oil.

However, the use of a polyol component containing only the silicone oil is not preferred because such a polyol component would have a high price and be disadvantageous with respect to cost. It is preferred that the polyurethane elastomer be produced from a polyol component that includes the silicone oil and a polycaprolactone ester polyol having low-temperature characteristics superior to other polyester polyols.

Because the silicone oil has hydroxyl groups at both ends, it reacts with the isocyanate component so that it is incorporated into a molecule, and does not produce a contamination which will bleed. Inclusion of the ester group can improve the compatibility with the isocyanate component. The product does not become cloudy when it is produced with the aromatic isocyanate and the isocyanate prepolymer. The physical properties of the polyurethane elastomer resulting therefrom preferably become uniform.

The molecular weight of the silicone oil is preferably from 1,000 to 10,000, more preferably from 2,000 to 6,000. When the silicone oil has a molecular weight of from 1,000 to 10,000, the polyurethane elastomer produced from that oil will produce a cleaning blade for an electronic copying machine which advantageously has a hardness that is not too high and a suitable elasticity.

The silicone oil used to produce the elastomers of the present invention may be formed from a silicone moiety and an ester moiety. The term “silicone moiety” means a moiety containing (1) a siloxane bond (Si—O), and (2) a hydrogen atom, an aliphatic group (1-30 carbon atoms) (especially an alkyl group), an aromatic group (6-30 carbon atoms) or an araliphatic group (7-30 carbon atoms) which is bonded (usually directly) to silicon or oxygen in the siloxane linkage. The silicone moiety is a moiety remaining after excluding the ester moiety from the silicone oil. The ester moiety means the organic acid moiety (namely, a moiety remaining after excluding a hydrogen atom from an organic acid) which forms an ester. Generally, the acid which forms an organic acid moiety is a fatty acid (preferably, a fatty acid having 2-30 carbon atoms).

Generally, it is preferred that the silicone oil be a silicone oil in which a part of the methyl group of the dimethyl silicone oil has been replaced by a higher fatty acid ester. Generally the higher fatty acid is a fatty acid having 10-30 carbon atoms.

The silicone (especially one with a dimethyl siloxane group) content in the silicone oil is preferably from 30 to 70% by weight, more preferably from 40 to 60% by weight. When the silicone content is from 30 to 70% by weight, the coefficient of friction of the resultant polyurethane elastomer becomes so small that it gives a low friction. The ester group content in the silicone oil is preferably from 30 to 70% by weight, more preferably, from 40 to 60% by weight.

In this specification, the “silicone content” means the weight % of the silicone moiety based on the silicone oil, and the “ester group content” means the weight % of the ester moiety based on the silicone oil.

When the ester group content is from 30 to 70% by weight, suitable physical properties, such as strength for the polyurethane elastomer for cleaning blade of electronic copying machine, are achieved.

The content of the silicone oil in the polyurethane elastomer is preferably from 5.0 to 50% by weight. 5.0 to 40% by weight silicone oil is even more preferred. When the silicone oil content is in the range from 5 to 50% by weight, the coefficient of friction of the polyurethane elastomer for a cleaning blade of electric copying machine will be small, and suitable physical properties will be acquired.

It is preferred to use a polycaprolactone ester polyol as the polyol component in addition to the silicone oil. Examples of suitable polycaprolactone ester polyols include polycaprolactone ester polyols having an average functionality of 2 to 3 and an average molecular weight of 500 to 3,000. Such polycaprolactone ester polyols can be prepared by ring-opening polymerization of epsilon-caprolactone with an initiator, for example, a glycol such as ethylene glycol, diethylene glycol, dipropylene glycol or a triol such as glycerol, trimethylol propane or trimethylol ethane. A polycaprolactone ester polyol having an average functionality of 2 to 3 and an average molecular weight of 2,000 to 3,000 is preferred.

More preferred is a diol having a functionality of 2 and an average molecular weight of 2,000 to 3,000. Most preferred is a diol having a functionality of 2 and an average molecular weight of 2,000 to 2,500.

The elasticity of the polyurethane elastomer is decreased, if the average molecular weight is smaller than 500. If the average molecular weight is larger than 3,000, an isocyanate prepolymer prepared by reacting the aromatic isocyanate with the polyol has high viscosity so that the workability worsens. The polycaprolactone ester polyol may be used alone or in combination with other such polyols.

Suitable amounts of the polycaprolactone ester polyol are preferably from 8.0% to 70% by weight, more preferably from 10.0% to 65% by weight, based on the polyurethane elastomer.

When the silicone oil content of the polyol component is in the range of 5 to 50% by weight, based on the weight of the polyurethane elastomer, and the content of the polycaprolactone ester polyol in the range of 8.0 to 70% by weight, based on to the polyurethane elastomer, the polyurethane elastomer for a cleaning blade of an electric copying machine has a glass transition temperature of at most −5 degrees C., little temperature dependence and a variation of tan delta value which is at most 0.30 at the temperature range between 10 degrees C. and 55 degrees C.

The silicone oil and the polycaprolactone ester polyol may used by mixing either with other materials in the polyol component or with the isocyanate component. They may be mixed with both other materials in the polyol component and with the isocyanate component.

When using by mixing the silicone oil and the polycaprolactone ester polyol with the isocyanate component, it is preferred to react them with the aromatic isocyanate first to give a uniform isocyanate group-terminated prepolymer (referred to as “NCO-terminated prepolymer”), to obtain better compatibility and physical properties of the polyurethane elastomer.

The NCO content of the silicone oil and the polycaprolactone ester polyol-containing NCO-terminated prepolymer is preferably from 8% to 25%, more preferably from 10% to 20%. The viscosity is preferably from 100 mPas to 3,000 mPas at 70 degrees C., more preferably, from 400 to 2,000 mPas at 70 degrees C. The viscosity range of 100 to 3,000 mPas at 70 degrees C. is advantageous because workability of the prepolymer is relatively easy.

Examples of suitable aromatic isocyanates useful as the isocyanate component include 4,4′-diphenyl methane diisocyanate (MDI), toluene diisocyanate (TDI), carbodiimide-modified MDI, polymethylene polyphenylene polyisocyanate (polymeric MDI) and naphthylene diisocyanate (NDI). These may be used alone or in combination. Among these, MDI is preferred.

As the chain extender, conventionally known low-molecular weight hydroxy compounds can be used. Examples of suitable chain extenders include: glycols such as 1,4-butane diol, 1,6-hexane diol, ethylene glycol, diethylene glycol and neopentyl glycol; polyhydric alcohols having valence of three or more, such as trimethylol propane, glycerol, diglycerol and pentaerythritol; and amino polyhydric alcohols such as diisopropanol amine, triisopropanol amine and triethanol amine. Glycols and trihydric alcohols are preferred.

The amount of the chain extender may be from 1% to 50% by weight, preferably, from 3% to 20% by weight, based on the polyurethane elastomer.

Conventionally known urethanization catalysts, fillers, coloring agents and antioxidants, etc. can be included in the polyol component or used in addition to the polyol component and the chain extender.

Dimethyl polysiloxane having a viscosity of 350 to 12,500 mPa·s at 25 degrees C. can be used as an antifoaming agent, in an amount of 0.001% to 0.02% by weight based on the polyurethane elastomer. Dimethyl polysiloxane may be used in the formulated polyol side, and since dimethyl polysiloxane does not react with isocyanate, dimethyl polysiloxane may also be used in the isocyanate component side.

Since the presence of dimethyl polysiloxane eliminates the bubbles of a mixture between the formulated polyol and the isocyanate component when preparing the polyurethane elastomer, the formation of large bubbles on the polyurethane elastomer is eliminated and the decrease of strength due to the presence of such bubbles is avoided. The coefficient of friction becomes small due to the lubricity of dimethyl polysiloxane.

In the production of the polyurethane elastomer for a cleaning blade of an electronic copying machine in accordance with the present invention, the mixing ratio of the formulated polyol to the isocyanate component [NCO index (equivalence ratio of an isocyanate groups to hydroxyl groups)] is preferably from 0.95 to 1.15, more preferably, from 1.05 to 1.10.

The polyurethane elastomer for a cleaning blade of an electronic copying machine of the present invention is preferably not foamed and is prepared without using a blowing agent such as water. The density of the polyurethane elastomer is preferably 1.00 g/cm³ or more. The lack of foaming can easily give the viscoelasticity suitable for the polyurethane elastomer for a cleaning blade of an electronic copying machine, because a urea bond will not be generated, for example, by the reaction of water and the isocyanate component. The density of at least 1.00 g/cm³ can give the low-friction and mechanical properties suitable for a polyurethane elastomer to be used for a cleaning blade of an electronic copying machine. If the polyurethane elastomer increases the volume to decrease the density, it is hard to obtain the desired low friction, since the silicone oil will be dispersed in the polyurethane elastomer and the amount of silicone oils on the surface of the polyurethane elastomer is decreased.

The polyurethane elastomers prepared in the above-described manner with the above-described materials have a hardness by Shore A of 70-90, a tan delta value of at most 0.32 at 10 degrees C., a tan delta value of at least on 0.02 at 55 degrees C., and little temperature dependency because the variation range of the tan delta value is at most 0.30 at a wide range of atmospheric temperatures (for example, between 10 degrees C. and 55 degrees C.).

In addition, since the glass transition temperature is at most −5 degrees C., the polyurethane elastomer has excellent low-temperature characteristics, good viscoelasticity even at the low-temperature range of at most 10 degrees C.

Since the variation range of viscoelasticity is small over a wide range of atmospheric temperature, the product polyurethane elastomer is the optimal polyurethane elastomer for a cleaning blade of an electronic copying machine which can be used under various atmosphere temperatures.

### EXAMPLES

The present invention will be specifically described with reference to the following Examples. The present invention is not limited to these Examples. Additionally, in Examples, “part” means “part by weight”, “%” means “% by weight” if not otherwise specified.

### Preparation of Silicone Oil-Containing NCO-Terminated Prepolymer (B)

While maintaining 100 g of dissolved liquid MDI at 50 degrees C., 98 g of X22-6132 (a bifunctional silicone oil with OH number of 25 mg KOH/g, MW of about 4,500, silicone content of 40%, ester group content of 60%, two OH-groups at the ends, manufactured by Shin-Etsu Chemical Co., Ltd.) heated to 60 degrees C. were added to the MDI. 0.007 g of SH200 as antifoaming agent (dimethylpolysiloxane manufactured by Toray Silicone Co., Ltd., viscosity: 1,000 mPas at 25 degrees C.) were also added. The resultant mixture was reacted at 80 degrees C. for 4 hours. The resultant NCO-terminated prepolymer (B) had an NCO content of 16% and a viscosity of 420 mPas at 70 degrees C. Further, turbidity such as white turbidity was hardly observed.

### Preparation of Polycaprolactone Ester Polyol-Containing NCO-Terminated Prepolymer (A)

While maintaining 100 g of dissolved liquid MDI at 50 degrees C., 119 g of Praccel 220 (PCL220: a difunctional polycaprolactone ester polyol with an OH number of 56 mgKOH/g, MW of about 2,000, manufactured by Daicel Chemical Industries, Ltd.) heated at 60 degrees C. were added to the MDI. 0.007 g of SH200 as antifoaming agent (dimethylpolysiloxane manufactured by Toray Silicone Co., Ltd., viscosity: 1,000 mPas at 25 degrees C.) were also added. The resultant mixture was reacted at 80 degrees C. for 4 hours.

The resultant NCO-terminated prepolymer (A) had an NCO content of 13% and a viscosity of 580 mPas at 70 degrees C.

### Method of Preparing Polyurethane Elastomer Molded Article for Measuring Test of Physical Properties and Viscoelasticity

(1) A polyol component heated at 100 degrees C. was added to one of the above-described NCO-terminated prepolymers heated at 100 degrees C., mixed and stirred by a propeller type mixer for about 60 seconds. The resultant mixed liquid was poured into an iron mold (size: 150×200×2 mm) heated at 140 degrees C. to make the molding. Being demolded in 30 minutes after pouring, post curing was conducted in an oven at 110 degrees C. for 16 hours. The molding was thereafter cured at ambient temperature for 1 week before the physical properties were measured.

A test sample (film) for measuring viscoelasticity having a thickness of 10 mil was prepared in such a way that the mixed liquid was poured in a mold under the same conditions as were used to prepare the molding by the above-described procedure. A blade was dragged without closing a lid.

### Test Method for Measuring a Glass Transition Temperature (a Peak Temperature and a Tan Delta Value) and a Tan Delta Value at 10 to 55 Degrees C.

(1) Test sample size for measurement: 10×20×0.254 mm (10 mil thickness)

(2) A DMS-220 model manufactured by Seikoh Chemicals Co., Ltd, was used to measure viscoelasticity at a frequency of 10 Hz in a temperature range of −60 degrees C. to 80 degrees C., raising the temperature at a rate of 2 degrees C./min, to measure a peak temperature and tan delta at the glass transition temperature, and tan delta at 10 to 55 degrees C.

(3) tan delta is an index showing viscoelasticity in a test method for measuring viscoelasticity (in accordance with JIS K7244).

### 2. Determination Criteria of Viscoelastic State (Change)

(1) Bad, when a glass transition temperature takes place at 10 to 55 degrees C.
(2) State at 10 degrees C. (low temperature)

It has been determined that when the tan delta value is 0.32 or less, it has an appropriate viscoelasticity and is good. When the tan delta value is more than 0.32, it is insufficient (inferior)

(3) State at 55 degrees C. (High Temperature)

It has been determined that when the tan delta value is 0.02 or more, it has an appropriate viscoelasticity and is good. When the tan delta value is 0.02 or less, it has an excessive viscoelasticity.

(4) The state of viscoelasticity change was determined from the range of change in tan delta value at 10 to 55 degrees C.

It has been determined that when the range of change in the tan delta value is within 0.30, the change of viscoelasticity is small and is good (superior). When the change of viscoelasticity is large (i.e., more than 0.30), it is bad (inferior).

### Example 1

As shown in Table 1, a silicone oil, PCL220 and a chain extender were mixed so that the silicone oil was 14.1 wt % and PCL220 was 70.5 wt % in a formulated polyol.

100 g of the formulated polyol and 78 g of the NCO-terminated prepolymer (A) were mixed and stirred to undergo a curing reaction, and a molded article of polyurethane elastomer was prepared in such a way that the content of silicone oil was 7.9 wt % and the content of PCL (polycaprolactone ester polyol) was 63.4 wt %.

The resultant polyurethane elastomer had good viscoelasticity with a hardness of 82 in Shore A, a glass transition temperature of −6.7 degrees C., and a tan delta value at 10 degrees C. of 0.214, and a range of change in tan delta value at 10 to 55 degrees C. was 0.185. In comparison with Comparative Example 1, the polyurethane elastomer, having an excellent low-temperature performance and small temperature dependence with the range of change in tan delta value at 10 to 55 degrees C. of at most 0.30, was obtained.

### Example 2

As shown in Table 1, silicone oil and a chain extender were mixed so that silicone oil was 45.5 wt % in a formulated polyol. 100 g of the formulated polyol and 22.7 g of the NCO-terminated prepolymer (A) were mixed and stirred to undergo curing reaction, a molded article of polyurethane elastomer was prepared in such a way that the content of the silicone oil was 37.1 wt % and the content of PCL was 10.0 wt %.

The resultant polyurethane elastomer had good viscoelasticity with a hardness of 84 in Shore A, a glass transition temperature of −8.0 degrees C., and a tan delta value at 10 degrees C. of 0.164, and the range of change in tan delta value at 10 to 55 degrees C. was 0.102. In comparison with Comparative Example 1, polyurethane elastomer, having an excellent low-temperature performance and small temperature dependence with the range of change in tan delta value at 10 to 55 degrees C. of at most 0.30, was obtained.

### Example 3

As shown in Table 1, PCL 220 and a chain extender were mixed so that PCL220 was 84.4 wt % in a formulated polyol. 100 g of the formulated polyol and 77 g of the NCO-terminated prepolymer (B) were mixed and stirred to undergo curing reaction, a molded article of polyurethane elastomer was prepared in such a way that the content of silicone oil was 21.5 wt % and the content of PCL was 47.7 wt %.

The resultant polyurethane elastomer had good viscoelasticity with a hardness of 78 in Shore A, a glass transition temperature of −5.4 degrees C., and a tan delta value at 10 degrees C. of 0.299, and the range of change in tan delta value at 10 to 55 degrees C. was 0.263. In comparison with Comparative Example 1, the polyurethane elastomer, having an excellent low-temperature performance and small temperature dependence with the range of change in tan delta value at 10 to 55 degrees C. of at most 0.30, was obtained.

### Comparative Example 1

A molded article of polyurethane elastomer was prepared in such a way that neither a formulated polyol nor an isocyanate component was mixed with a silicone oil.

The resultant polyurethane elastomer had insufficient viscoelasticity with a hardness of 85 in Shore A, a glass transition temperature of −2.0 degrees C., and a tan delta value at 10 degrees C. of 0.391, and had large temperature dependence with the range of change in tan delta value at 10 to 55 degrees C. of as large as 0.362.

TABLE 1

| | Example 1 | | | |
|---|---|---|---|---|
| | (part by | | | Comparative |
| | weight) | Example 2 | Example 3 | Example 1 |
| Formulated polyol | | | | |
| (1) Polyol component | | | | |
| Silicone oil | 11 | 10 | | |
| PCL220 | 55 | | 65 | 65 |
| (2) Chain extender | | | | |
| 1,4-Butanediol | 10.8 | 10.8 | 10.8 | 10.8 |
| Trimethylol propane | 1.2 | 1.2 | 1.2 | 1.2 |
| In formulated polyol | | | | |
| Amount of silicone oil (wt %) | 14.1 | 45.5 | 0 | 0 |
| Amount of PCL220 (wt %) | 70.5 | | 84.4 | 84.4 |
| (3) Isocyanate component | | | | |
| (part by weight) | | | | |
| NCO-terminated prepolymer (A) | | | | |
| Aromatic isocyanate: MDI | 100 | 100 | | 100 |
| Polyol component: PCL220 | 119 | 119 | | 119 |
| SH200(1000) | 0.007 | 0.007 | | |
| NCO-terminated prepolymer (B) | | | | |
| Aromatic isocyanate: MDI | | | 100 | |
| Polyol component: silicone oil | | | 98 | |
| SH200(1000) | | | 0.007 | |
| In NCO-terminated prepolymer | | | | |
| Amount of silicone oil (wt %) | 0 | 0 | 49.5 | 0 |
| Amount of PCL220 (wt %) | 54.3 | 54.3 | 0 | 54.3 |
| NCO content (%) | 13 | 13 | 16 | 13 |
| Viscosity (mPas at 25° C.) | 580 | 580 | 420 | 580 |
| Mixing ratio of formulated polyol/ | 100/78 | 100/22.7 | 100/77 | 100/77 |
| isocyanate component | | | | |
| (part by weight) | | | | |
| NCO index | 1.07 | 1.07 | 1.07 | 1.07 |
| In polyurethane elastomer | | | | |
| Amount of silicone oil (wt %) | 7.9 | 37.1 | 21.5 | 0 |
| Amount of PCL220 (wt %) | 63.4 | 10.0 | 47.7 | 71.3 |

TABLE 2

| | Exam- | Exam- | Exam- | Comparative |
|---|---|---|---|---|
| | ple 1 | ple 2 | ple 3 | Example 1 |
| 1. Physical properties of | | | | |
| polyurethane elastomer | | | | |
| Shore A hardness (20° C.) | 82 | 84 | 78 | 85 |
| Modulus (MPa) | | | | |
| 100% | 5.2 | 7.1 | 4.6 | 8.8 |
| 200% | 8.7 | 13.5 | 8.2 | 16.4 |
| 300% | 16.8 | — | 15.7 | — |
| Strength at break (MPa) | 22.1 | 22.3 | 20.1 | 20.9 |
| Elongation at break (%) | 330 | 260 | 320 | 240 |
| Tear strength (kN/m) | 69.8 | 65.6 | 57 | 73 |
| 2. Viscoelasticity | | | | |
| Glass transition temperature | −6.7 | −8.0 | −5.4 | −2.0 |
| (peak temperature ° C.) | | | | |
| tan delta value | 0.446 | 0.228 | 0.475 | 639 |
| Tan delta value at each | | | | |
| temperature (° C.) | | | | |
| 10 | 0.214 | 0.164 | 0.229 | 0.391 |
| | (good) | (good) | (good) | (insufficient) |
| 23 | 0.093 | 0.112 | 0.136 | 0.133 |
| 40 | 0.045 | 0.077 | 0.057 | 0.043 |
| 55 | 0.029 | 0.062 | 0.036 | 0.029 |
| Range of change | 0.185 | 0.102 | 0.263 | 0.362 |
| from tan delta (10) | (good) | (good) | (good) | (bad) |
| to tan delta (55) | | | | |

Preferred applications for the polyurethane elastomer of the present invention, since temperature dependence is small, particularly excellent in elasticity at low temperature range, are listed blades or rolls for cleaning and the like of electronic copying machines such as a facsimile machine, a copier and a printer because they are suitable for use under various atmospheric temperatures.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyurethane elastomer for a cleaning blade of an electronic copying machine, the polyurethane elastomer comprising the reaction product of:
(1) a polyol component comprising a bifunctional silicone oil having hydroxyl groups at both ends and also an ester group;
(2) a chain extender, and
(3) an isocyanate component comprising an aromatic isocyanate;
characterized by
(a) a silicone oil content of from 5.0 to 50% by weight, based on weight of the polyurethane elastomer;
(b) a hardness of 70 to 90 in Shore A,
(c) a tan delta (10) value at 10 degrees C. of 0.32 or less,
(d) a tan delta (55) value at 55 degrees C. of 0.02 or more in viscoelasticity, and
(e) a difference between tan delta (10) and tan delta (55) which is within 0.30.

2. The polyurethane elastomer of claim 1 in which the silicone oil has a molecular weight of 1,000 to 10,000, a silicone content of from 30 to 70% by weight and an ester group content of from 30 to 70% by weight.

3. The polyurethane elastomer of claim 1 in which the polyol component comprises a polycaprolactone ester polyol having a functionality of 2 to 3 and an average molecular weight of 500 to 3,000.

4. The polyurethane elastomer of claim 1 in which the polyol component comprises a polycaprolactone ester polyol having a functionality of from 2 to 3 and an average molecular weight of from 2,000 to 3,000.
